(19) United States
(12) Patent Application Publication
(10) Pub. No.: US 2005/0144131 A1
(43) Pub. Date: Jun. 30, 2005

(54) Method for electronically exchanging checks between financial institutions and an improved process for clearing checks

(76) Inventor: Andy S. Aziz, Fairfield, CT (US)

Correspondence Address: EUGENE LIEBERSTEIN, 2151 LONG RIDGE ROAD, STAMFORD, CT, 06903, US

(21) Appl. No.: 11/021,033

(22) Filed: Dec. 23, 2004

Related U.S. Application Data
(60) Provisional application No. 60/533,237, filed on Dec. 31, 2003.

(51) Int. Cl. G06F 17/60

(52) U.S. Cl. 705/42; 705/45

(57) ABSTRACT

A method for electronically transmitting or transferring checks between financial institution(s) particularly between an Originating Depository Financial Institution (ODFI) and a receiving banking financial institution (RDFI) comprising scanning each of the check(s) to electromagnetically read “MICR” line information printed on each check; capturing an image of the front and back of each check; forming a computer document file of the scanned MICR line information for each check; transmitting the computer file over the internet via e-mail to the receiving depository financial institution (RDFI) upon which the check is drawn using the e-mail address consisting of the ABA routing number and the corresponding domain name of the receiving depository financial institution (RDFI) as currently maintained by the RDFI financial institution and returning the original check(s) to the maker(s) account or a substitute image thereof.

### FIELD OF INVENTION

This invention relates to the field of check handling between banking institutions in the process of clearing checks.

### BACKGROUND OF INVENTION

In today's check processing environment a check or similarly implemented “instrument” written by a consumer is typically transacted to another individual or business entity for goods or services. When consumer or business entity A “Maker/Payor” delivers a check to a consumer or business entity B designated as the “Payee”, it is typically drawn off the Maker's financial institution which may represent any financial institution such as a bank, credit union, savings & loan, credit line, investment account or other such entity organized under national or state banking laws and deemed a financial institution. The check is “cleared” through the receiving financial institution (RDFI). The “clearing process” as is conventionally practiced involves:

(1) Maker writes a check of his/her/its Demand Deposit Account (DDA) from their financial institution, the RDFI (Receiving Depository Financial Institution).

(2) Maker/Payor delivers the check to the Payee.

(3) Payee endorses the check in the top one and a half inch space allotted as per regulations.

(4) Payee then delivers the check in one fashion or another to its financial institution, the ODFI (Originating Depository Financial Institution) for deposit into its Demand Deposit Account (DDA).

(5) The ODFI financial institution images the MICR information from the bottom front of the check and takes an image of the check fro storage in microfiche form or any other format for its own records and then posts credit to Payee's DDA.

(6) The ODFI financial institution delivers the physical check back to the RDFI through one of several means of which the most common include: (a) the delivery or exchange through a local clearing house; (b) the delivery or exchange through a correspondent bank system; (c) special arrangement for direct transfer known as “direct send” or (d) the delivery or exchange using the federal reserve.

At present delivery by means of the above methods occurs as follows:

Delivery or exchange through the Local Clearing House: This is a system in which the major financial institutions in a marketplace “fine sorts” their received and processed checks by ABA routing number contained in the MICR line to identify those participating member financial institution in the local clearing house. They then physically exchange trays/boxes of checks drawn on one another's financial institutions whereby Maker/Payor's check drawn on Maker/Payor's financial institution and presented for deposit to Payee's DDA at Payee's financial institution will be processed as explained above and physically handed over to a representative from Maker/Payor's financial institution. Each representative will then deliver all of their own “on-us” checks back to their respective financial institutions for further processing.

Delivery through the Correspondent Bank system: This method of clearing checks is one in which financial institutions within a local region are known to each other to route cleared and processed checks through another specific and usually larger financial institution who will act as a centralized point for all the local banks to route the checks drawn on their ABA/RT number. The ODFI will “fine sort” their received and processed checks by ABA/RT number contained in the MICR line to identify those financial institutions that have instructed them and all other local financial institutions to forward their cleared and processed work to a specific financial institution (the Correspondent Bank) for further forwarding to the end RDFI. The Correspondent Bank will accumulate all the checks from the ODFIs and forward a “cash letter” to the respective RDFIs for further processing.

Delivery by means of “Direct Send” is the process in which a financial institution will “fine sort” their received and processed checks by ABA/RT number contained in the MICR line and to identify those RDFIs that it has a special arrangement with to send their check directly to them in the most expedient manner possible, usually via overnight mail or via ground courier to the airport to make a specific flight to a specific city where the RDFIs processing center is located and further picked up by ground courier and brought directly to the RDFI for further processing.

Delivery through the local Federal Reserve for intra-district “local” items: This is the system in which the ODFI “fine sorts” their received and processed checks by ABA/RT number contained in the MICR line to identify those checks that are not cleared through the Local Clearing House, are not cleared through the Correspondent Banking system nor cleared through the Direct Send method yet still need to be returned to an RDFI within the same Federal Reserve district. The Federal Reserve will accept the processed checks from the ODFI and credit their Federal Reserve account for the amount of the “cash letter” and proceed to “fine sort” the items within the cash letter to each of the RDFIs within their district. The Federal Reserve will charge each of the RDFI accounts for the checks, thus keeping their own books in balance, and deliver the physical checks to the RDFI for further processing.

Delivery through the local Federal Reserve for other Fed district is the system in which the ODFI “fine sorts” their received and processed checks by ABA/RT number contained in the MICR line to identify those checks that are not cleared through the Local Clearing House, are not cleared through the Correspondent Banking system, are not cleared through the Direct Send method nor cleared through the Local Federal Reserve district. These items need to be sent to an RDFI outside the Federal Reserve district in which the ODFI has received the check for processing. The ODFI will send the checks to the correct and respective Federal Reserve district who will accept the processed checks from the ODFI and credit their Federal Reserve account for the amount of the “cash letter” and proceed to “fine sort” the items within the cash letter to each of the RDFIs within their district. The Federal Reserve will charge each of the RDFI accounts for the checks, thus keeping their own books in balance, and deliver the physical checks to the RDFI for further processing.

Once the checks are delivered from the ODFI to the RDFI through whichever of the above identified methods or any other conventional method and the settlement of funds has been finalized such that the ODFI has given funds to their customer and has received the same amount of funds from their settlement with the RDFI, the ODFI is even and further processing by the RDFI then involves making an image i.e., “capturing” the MICR line information on the check and charging the Maker/Payor's account for the face amount of the check. The captured image must adhere to industry standards as set forth in Check 21 and X9B banking regulations and requirements.

Only then is the RDFI finally in a position to either return the original check back to the Maker/Payor with their bank statement or to send an image of the check back to the Maker/Payor with their bank statement. Alternatively, the RDFI may make an image of the paid check available to the Maker/Payor on the RDFI's website to be accessed by the Maker/Payor.

With the advent of Check 21, checks are “cleared” through the financial institution of the Receiver financial institution. The “clearing process” after the endorsed check is deposited in the ODFI (Originating Depository Financial Institution) of the payee for deposit into its DDA account, involves the ODFI “capturing” the MICR information from the bottom front of the check, posting credit to the payee's account, making an image of the front and back of the check and transmitting the check or batch of checks to a third party check processor or directly to their depository financial institution. If the checks are sent to the third party check processor, the checks can be converted into ACH transactions as regulated by NACHA or the third party processor can print the checks as “substitute checks” and process them through the paper check process of clearing the checks based on their origination. If the checks are sent to the financial institution, the ODFI (Originating Depository Financial Institution) for deposit into its DDA, the checks can be converted into ACH transactions as regulated by NACHA or the financial institution can print the checks as “substitute checks” and process them through the paper check process of clearing the checks based on their origination. If the checks are sent to either the third party check processor or the financial institution, the check images can be further transmitted to any number of printers in any number of locations where the checks can be directed by ABA routing number, printed and processed for immediate availability.

In today's e-check environment, the consumer has demanded that their original checks or an image of their paid (canceled) check be returned to them. In turn NACHA on behalf of the public has asked check processors to maintain two databases of “opt-in” and “opt-out” where the consumer chooses or refuses to have their check converted to an electronic transaction. This process is costly, slow and sometimes ineffective. It also slowed the growth of e-check and has discouraged the use of substitute images for checks since the savings to be realized by converting the checks is wasted in creating and maintaining two databases.

### SUMMARY OF THE INVENTION

In accordance with the present invention checks can be electronically transmitted or transferred checks between financial institution(s) organized under national or state banking laws following presentment of the check(s) to the originating depository financial institution (“ODFI”) for deposit or payment comprising the steps of:
scanning each of the check(s) to electromagnetically read the “MICR” line information printed on each check inclusive of the routing transit number (ABA number) of the financial institution upon which the maker draws the check (“RDFI banking institution”) and the check number;
capturing an image of the front and back of each check;
forming a computer document file of the scanned MICR line information for each check;
transmitting the computer file over the internet via e-mail to the receiving depository financial institution upon which the check is drawn using the e-mail address consisting of the ABA routing number and the corresponding domain name of the receiving depository financial institution as currently maintained by the RDFI and
returning the original check(s) to the maker(s) account or a substitute image thereof. When the RDFI receives the file, it will be able to make the image of the check available to the Maker/Payor as a printed IRD (Image Replacement Document), or as images of multiple checks on a single page, or upload the images of the Makers/Payor checks to the Maker/Payor via the RDFIs website.

The method of exchanging checks in accordance with the present invention is particularly suited to the conventional check clearing process without the necessity of physical delivery of the original checks permitting fund settlement to be expedited.

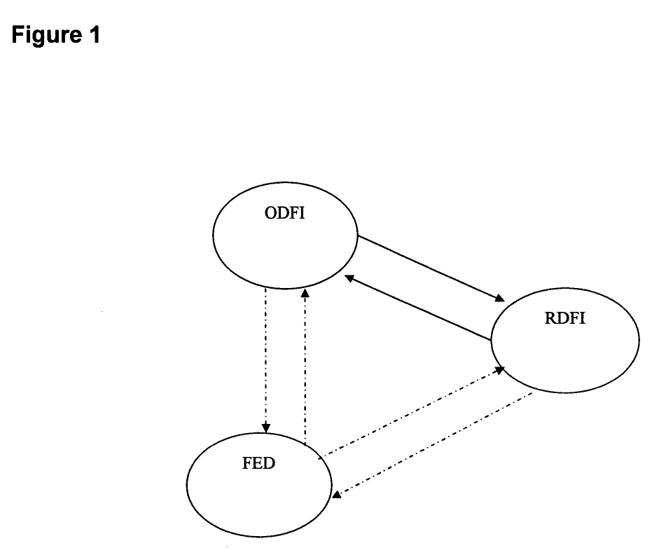

Other advantages will become apparent form the following description of the invention when read in conjunction with the accompanying FIG. 1 representing an illustration of check exchange in accordance with the present invention.

### DETAILED DESCRIPTION OF THE INVENTION

In accordance with the present invention check clearing is implemented as follows: A check or similarly implemented “instrument” written by an entity is typically transacted to another individual or business entity for goods or services. When consumer or business entity A “Maker/Payor” delivers a check to consumer or business entity B “Payee”, it is typically drawn off Maker/Payor's financial institution (bank, credit union, savings & loan, credit line, investment account or other such entity deemed a financial institution) and is “cleared” through the financial institution of the Payee as follows:

Maker/Payor issues a check of his/her/its Demand Deposit Account (DDA) from their financial institution, the RDFI (Receiving Depository Financial Institution).

Maker/Payor delivers the check to the Payee.

Payee endorses the check in the top one and a half inch space allotted as per regulations.

Payee deposits the check in one fashion of another to its financial institution, the ODFI (Originating Depository Financial Institution) for deposit into its DDA.

ODFI “captures” the MICR information from the bottom front of the check and captures an image of the check in microfiche or other forms for its own records and posts credit to Payee's DDA.

The ODFI delivers the captured image (front and back) of the check back to the RDFI by forming a computer document file of the scanned MICR line information for each check; transmitting the computer file over the internet via e-mail to the “RDFI” receiving depository financial institution upon which the check is drawn using the e-mail address consisting of the ABA routing number and the corresponding domain name of the RDFI as currently maintained by the RDFI and returning the original check(s) to the maker(s) account or a substitute image thereof. The RDFI may make the image of the check available to the Maker/Payor as a printed IRD (Image Replacement Document), or as images of multiple checks on a single page, or upload the images of the Makers/Payor checks to the Maker/Payor via the RDFIs website.

The process of this invention allows every financial institution in the role of the ODFI the ability to send the captured image back to Maker/Payor's bank—the RDFI, through a bank specific transfer medium and eliminates the need for Financial Institutions to establish an Image Exchange agreement between themselves as many have presently done which is unnecessary.

It should be understood that the bank specific transfer medium in accordance with the present invention uses a bank e-mail address or an FTP site that is comprised of its ABA Routing Transit number and the financial institution's domain name such as, e.g. 322271627@washinatonmutual.com. Each bank's computer system has access to the list of ABA Routing numbers and the corresponding financial institution's name since all such names are outlined in the Thompson Directory @ the bank's internet domain name. Other examples are as follows:

011900571@fleetbank.com “011900571” is constant for the email address for each FI and “bankdomain” is the RTN of the FI followed by a given and specific extension “.xxx” possible created specifically for this venture.

Additional Examples:
For Fleet Bank the address would be for RTN # 011900571;
011900571@fleet.com.
For Wachovia Bank the address would be for RTN # 021101108;
021101108@wachovia.com
For Citi Bank the address would be for RTN # 021000089;
021000089@citibank.com and
For Peoples Bank the address would be for RTN # 221172186;
221172186@Peoples.com

The RTN is cross-referenced to the financial institution's domain name. All check images for that RTN/Domain are complied or aggregated in the currently agreed upon CTA format of “X9.37 ECP ANSI File Format Standard” which includes MICR line contents plus indexing methodology.

During the course of the day once the checks are processed and the checks posted to the Payee's DDA, the computers sort each check by ABA Routing number and create a separate file for each ABA Routing number that is comprised of each item's image (front and back) and MICR information. The file is then sent via email or FTP secure transfer (electronically) to the RDFI specific address as outlined above. Encryption of the file is recommended using conventional encryption technology for security.

Based upon the present invention checks will no longer have to be transported back to the RDFI using current conventional methods and no more Local Clearing House exchanges are needed. This also eliminates the need to sort the physical checks by ABA Routing number, move them from the processing area to the transportation area, load them into vans, drive them to the designated meeting place, swap and log all the transactions (cash letters), take the appropriate checks from each of the other Local Clearing House participants, load them into the van, drive them back to the transportation center and send them to the operations center for further processing as required. Moreover, no more clearing physical checks through the correspondent banking system is necessary and no warehousing or image exchange agreement between financial institutions will be necessary. Furthermore, once the RDFI have all the emails, it becomes easy for the computer to aggregate all the images by account number since the MICR line information are included.

In implementing the invention the RTN will be converted to the domain name as described above. Each FI is assigned a domain name in accordance with each of their RTNs. A FI with multiple RTNs will have multiple domain names to properly assign each image to the appropriate RTN domain. Once the email is received by the RDFI, it has the option to reprint the image as an IRD, post or upload the images to their proprietary Internet service or any other use as they see fit.

Below are some examples of how the check images will be transported from one financial institution to the other:

### EXAMPLES

1. A check is deposited at Bank X and drawn on Bank Y. Once the image is captured at Bank X, using the methodology of the present invention, that image can then be sent to Bank Y so that Bank Y can make the image available to their account holder who is the maker of that check that was deposited into Bank X.
   A check is deposited at Bank X and drawn on the same Bank (on-us check), in this case you will not need to use the methodology of the present invention since there will be no requirement to transport that check to another Bank.
   Glossary of Terms:

ABA: See RTN or Routing/Transit Number.

ACH: Automated Clearing House.

BAI File: Bank Administration Institute format for file exchange between banks and their clients.

CTA: Check Truncation Act—A law drafted by the Federal Reserve Board. The goal of the legislation is to increase efficiency of the nation's payment system by removing certain legal impediments to check truncation so that banks would be able to easily present and return checks electronically. It will not mandate the receipt of checks in electronic form, but would facilitate it. A new instrument called a “substitute check” created from an electronic check image will be the legal equivalent of the original check and could be processed by receiving banks just as original paper checks are.

Among the benefits touted by the Federal Reserve:
quicker collection and return of checks;
reduction of the industry's reliance on the physical transportation of checks;
reduction of infrastructure costs;
benefit to customers if the changes enable banks to offer broader deposit options, later cutoff hours, more timely information, and faster check collection and return.

FI: Financial Institution—Any bank, savings and loan, credit union or other institution organized under either national or state banking laws capable of both accepting deposits and making loans.

FTP: File Transfer Protocol.

IP Address: Internet Protocol Address.

IRD: Image Replacement Draft (or Document)—A substitute check within the check clearing system, speeding up the availability of funds.

MICR: Magnetic Ink Character Recognition (Line)—The characters on the bottom on the face of a paper check that contains the routing transit number of the financial institution the check is drawn on, the account number of the drawee (Receiver) and the check number, all printed in machine readable magnetic ink in a font devised for check reading.

NACHA: National Automated Clearing House Association.

ODFI: Originating Depository Financial Institution—The financial institution which delivers ACH entries directly or indirectly through a third party to its ACH operator.

RDFI: Receiving Depository Financial Institution—A financial institution which receives ACH entries directly of indirectly from its ACH operator.

RTN: Routing/Transit Number—Also knows as Routing Number, Transit/Routing Number and ABA number. A nine digit number (eight digits plus a check digit) which identifies a specific financial institution. Routing numbers are administered by the Routing Number Administrative Board under the sponsorship of the American Bankers Association and officially maintained and published by Thomson Financial Publishing.

X9.37 ECP Ansi: The standard format in which check 21 regulation had dictated that it is the format of image to follow to comply with the regulation.

1- A method for electronically transmitting or transferring checks between financial institution(s) organized under national or state banking laws following presentment of the check(s) to the originating depository financial institution (“ODFI”) for deposit or payment comprising the steps of:
scanning each of the check(s) to electromagnetically read “MICR” line information printed on each check inclusive of the routing transit number (ABA number) of the financial institution the check is drawn on by the maker (“RDFI banking institution”) and the check number;
capturing an image of the front and back of each check;
forming a computer document file of the scanned MICR line information for each check;
transmitting the computer file over the internet via e-mail to the receiving depository financial institution RDFI upon which the check is drawn using the e-mail address consisting of the ABA routing number and the corresponding domain name of the RDFI financial institution as currently maintained by the RDFI banking institution and
returning the original check(s) to the maker(s) account or a substitute image thereof.

2. A method according to claim 1 wherein the e-mail header contains the name of the transmitting financial institution.

3. A method according to claim 2 wherein the computer document file is encrypted before transmission over the internet.

4. In a method for clearing check(s) by an Originating Depository Financial Institution (ODFI) which are drawn for payment by a receiving banking financial institution (RDFI) of the maker the improvement comprising:
scanning each of the check(s) to electromagnetically read “MICR” line information printed on each check inclusive of the routing transit number (ABA number) of the receiving depository financial institution (RDFI) and the check number;
capturing an image of the front and back of each check;
forming a computer document file of the scanned MICR line information for each check;
transmitting the computer file over the internet via e-mail to the receiving depository financial institution (RDFI) upon which the check is drawn using the e-mail address consisting of the ABA routing number and the corresponding domain name of the receiving depository financial institution (RDFI) as currently maintained by the RDFI financial institution and
returning the original check(s) to the maker(s) account or a substitute image thereof.
